(19) United States
(12) Patent Application Publication
(10) Pub. No.: US 2005/0048349 A1
(43) Pub. Date: Mar. 3, 2005

(54) Method of manufacturing a fuel cell array and a related array

(76) Inventors: Megan A. Fannon, Latham, NY (US); Robert S. Hirsch, Troy, MI (US); Juan J. Becerra, Altamont, NY (US)

Correspondence Address: CESARI AND MCKENNA, LLP, 88 BLACK FALCON AVENUE, BOSTON, MA, 02210, US

(21) Appl. No.: 10/650,424

(22) Filed: Aug. 28, 2003

(51) Int. Cl. H01M 2/08; B05D 5/12; H01M 8/02; H01M 4/86; B29C 43/18

(52) U.S. Cl. 429/36; 264/259; 264/261; 427/115; 429/44; 429/38

(57) ABSTRACT

A process for fabrication and molding of a fuel cell, or an array of fuel cells is provided. The inventive process, in accordance with one aspect of the invention, includes diffusion layers being hot-press bonded onto current collectors. A catalyzed membrane is sandwiched between two current collectors integrated into the lead frames designed for use in a molding process. A raised surface on each current collector provides a means for shut off of the mold plates. A suitable moldable material is introduced into a mold cavity to form a frame around the current collectors, which provides a tight and secure seal, eliminating the need for gasketing, and which further also provides compression thus further eliminating screws, nuts and other fasteners.

### BACKGROUND OF THE INVENTION

1. Field of the Invention

This invention relates generally to fuel cells, and more particularly, to the manufacture of such fuel cells.

2. Background Information

Fuel cells are devices in which electrochemical reactions are used to generate electricity. A variety of materials may be suited for use as a fuel depending upon nature of the fuel cell. Organic materials, such as methanol or natural gas, are attractive fuel choices due to their high specific energy.

Fuel cell systems may be divided into “reformer-based” systems (i.e., those in which the fuel is processed in some fashion to extract hydrogen from the fuel before it is introduced into the fuel cell) or “direct oxidation” systems in which the fuel is fed directly into the cell without the need for separate internal or external processing. Most currently available fuel cells are reformer-based fuel cell systems. However, because fuel processing is complex, and requires expensive components, which occupy comparatively significant volume, the use of reformer based systems is presently limited to comparatively large, high power applications.

Direct oxidation fuel cell systems may be better suited for a number of applications in smaller mobile devices (e.g., mobile phones, handheld and laptop computers), as well as in some larger scale applications. In fuel cells of interest here, a carbonaceous liquid fuel in an aqueous solution (typically aqueous methanol) is applied to the anode face of a membrane electrode assembly (MEA). The MEA contains a protonically conductive, but electronically non-conductive membrane (PCM). Typically, a catalyst, which enables direct oxidation of the fuel on the anode aspect of the PCM, is disposed on the surface of the PCM (or is otherwise present in the anode chamber of the fuel cell). In the fuel oxidation process at the anode, the products are protons, electrons and carbon dioxide. Protons (from hydrogen in the fuel and water molecules involved in the anodic reaction) are separated from the electrons. The protons migrate through the PCM, which is impermeable to the electrons. The electrons travel through an external circuit, which includes the load, and are united with the protons and oxygen molecules in the cathodic reaction, thus providing electrical power from the fuel cell.

One example of a direct oxidation fuel cell system is a direct methanol fuel cell system or DMFC system. In a DMFC system, a mixture comprised predominantly of methanol and water is used as fuel (the “fuel mixture”), and oxygen, preferably from ambient air, is used as the oxidizing agent. The fundamental reactions are the anodic oxidation of the methanol and water in the fuel mixture into CO₂, protons, and electrons; and the cathodic combination of protons, electrons and oxygen into water. The overall reaction may be limited by the failure of either of these reactions to proceed at an acceptable rate (more specifically, slow oxidation of the fuel mixture will limit the cathodic generation of water, and vice versa).

Direct methanol fuel cells are being developed towards commercial production for use in portable electronic devices. Thus, the DMFC system, including the fuel cell and the other components should be fabricated using materials and processes that are not only compatible with appropriate form factors, but which are also cost effective. Furthermore, the manufacturing process associated with a given system should not be prohibitive in terms of associated labor or manufacturing cost or difficulty.

Typical DMFC systems include a fuel source, fluid and effluent management and air management systems, and a direct oxidation fuel cell (“fuel cell”). The fuel cell typically consists of a housing, hardware for current collection and fuel and air distribution, and a membrane electrode assembly (“MEA”) disposed within the housing.

A typical MEA includes a centrally disposed, protonically conductive, electronically non-conductive membrane (“PCM”). One example of a commercially available PCM is NAFION® a registered trademark of E.I. Dupont de Nemours and Company, a cation exchange membrane comprised of polyperflourosulfonic acid, in a variety of thicknesses and equivalent weights. The PCM is typically coated on each face with an electrocatalyst such as platinum, or platinum/ruthenium mixtures or alloy particles. On either face of the catalyst coated PCM, the electrode assembly typically includes a diffusion layer. The diffusion layer on the anode side is employed to evenly distribute the liquid fuel mixture across the anode face of the PCM, while allowing the gaseous product of the reaction, typically carbon dioxide, to move away from the anode face of the PCM. In the case of the cathode side, a diffusion layer is used to achieve a fast supply and even distribution of gaseous oxygen across the cathode face of the PCM, while minimizing or eliminating the collection of liquid, typically water, on the cathode aspect of the PCM. Each of the anode and cathode diffusion layers also assist in the collection and conduction of electric current from the catalyzed PCM.

As noted, the MEA is formed of a centrally disposed PCM that is sandwiched is between two catalyst layers. The catalyst layers of the MEA in some architectures can be arranged such that a gas diffusion layer (GDL) is adjacent the cathodic catalyst layer to allow oxygen to be transported to the cathode, and a liquid and gas diffusion layer (LDL/GDL) is adjacent the anodic catalyst layer that allow liquid fuel to be transported to the anode, and to allow carbon dioxide to travel away from the anode. Gaskets are often used to maintain the catalytic layers and the diffusion layers in place. Generally, the entire MEA is placed into a frame structure that both compresses the MEA and provides an electron path. Although this can provide some dimensional stability, the greater the compression that is required, the more physical components (i.e., screws, etc.) must be employed to assure adequate pressure. Those skilled in the art will recognize that sealing and application of significant pressure can be accomplished in various ways, but these aspects conventionally involve relatively large fastening components, such as screws, nuts and the like. Such components themselves can be expensive because they are specially machined. Furthermore, the assembly of devices that include these fasteners is a time consuming manual process that can also lead to inconsistency in results. Moreover, the additional parts can add weight, volume and cost to the fuel cell, which if used as a power source for hand-held electronic devices, should be of the smallest form factor possible.

As noted, it is also common to place gasketing around the exterior portions of the fuel cell to resist leaks of the fuel substance or water that is produced at the cathode out of the fuel cell. The gasketing can also be used to retain moisture in the fuel cell, as the NAFION® membrane operates ideally when sufficiently hydrated. The gasketing that is incorporated to prevent leakages is typically a deformable plastic material that is stretched and placed around the outer current conductor plates and usually handassembled around the lateral portions of the fuel cell. In accordance with a commonly owned, co-pending U.S. patent application Ser. No. 10/448,271, filed on May 30, 2003, by Hirsch, et al., for a FUEL EFFICIENT MEMBRANE ELECTRODE ASSEMBLY, which is incorporated by reference herein, a direct oxidation fuel cell is described in which the catalyst layers and diffusion layers can be extended beyond and overlap the gasketing to form an even greater seal than the gasketing would alone. In addition, the catalyzed portions of the membrane are extended into the area of the gasket to substantially resist the flow of fuel substance through any paths created at the edges of the diffusion layer between the diffusion layer and the gasket. Extending the catalytic layer into the area of the gasket allows methanol or other fuel substance to be oxidized on the catalyst prior to its leaking out of or around the diffusion layer. This aides in preventing undesired leakages but these gaskets must be manually placed in the proper location during manufacture. Additionally, the fuel cell still requires the use of screws, bolts and other fasteners to maintain the fuel cell components in place, and to maintain the proper compression required for electrical contact and leakage prevention.

More specifically, fuel cells contain a number of components. These components can include a fixture or base compression plate, a gasket, an anode current collector plate, a second gasket, a membrane electrode assembly, and yet another gasket, then the cathode current collector, a further gasket and a cathode compression plate. Depending on the size of the cell, a number of fasteners, typically four to eight screws and nuts may often be used to create compression required through all of these layers. Depending on the design of the current collectors, additional flow field plates may also be required at the anode, cathode or both.

Current fuel cell assembly techniques involve layering all of these components of the fuel cell by hand and then tightening the components together using several screws tightened to a specific torque. As this is accomplished by hand, this manufacturing technique results in variations in compressions from build to build, in addition to consuming significant assembly time per cell. In addition to DMFCs, other types of fuel cells, such as hydrogen-gas fueled fuel cells, conventionally require these manufacturing techniques, and have the same disadvantages.

Another aspect of typical fuel cell construction involves a hot pressing step. More specifically, during fuel cell construction, a membrane electrode assembly is first created, that includes a catalyzed membrane and a gas diffusion (GDL) layer material. (Sometimes, the gas diffusion layer material is simply referred to as a “diffusion layer.”) These components are laminated together in a hot press operation. This step, when performed separately, can also be time consuming.

There remains a need, therefore, for a process for manufacturing and assembling a fuel cell or a fuel cell array, which results in a product that does not require many screws, bolts or other fasteners to hold the components together or to maintain compression within the fuel cell. There remains a further need for a process for assembling a fuel cell, which either eliminates the need for gasketing between each layer of the fuel cell, or reduces the number of gasketing components needed. There remains yet a further need for a process that combines and automates several steps to save time and to produce more consistent results.

It is thus an object of the present invention to provide a cost-effective, highly efficient process for manufacturing a fuel cell or fuel cell array that allows the construction of a fuel cell with adequate compression without the use of screws, bolts and other fasteners. It is a further object of the invention to provide a fuel cell that has been produced by such process. It is yet a further object of the invention to provide a fuel cell that does not require multiple gaskets between and around the various layers and components of the fuel cell.

### SUMMARY OF THE INVENTION

The deficiencies and disadvantages of prior techniques have been overcome by the solutions provided by the present invention, which is a process for manufacturing a fuel cell and an associated fuel cell array that includes a unique lead frame that integrates current collectors and other components of the fuel cell that are inserted into a mold and thereby sealed. More specifically, the fuel cell components are assembled on a lead frame structure, which is used to facilitate the molding process. The lead frame, containing the previously assembled components of the fuel cell, is inserted into a mold cavity formed by the mold plate and a moldable material, such as plastic, is introduced into the mold cavity to create the frame around the cell. For purposes of this description, the term “mold plate” includes any component that imparts a desired shape or form to the moldable material it receives and which allows the moldable material when solidified, to assume the desired shape as the fuel cell frame. Once the frame is set, the fuel cell frame seals the edges of the fuel cell against leaks. This eliminates the need for gaskets. The frame also holds the components of the cell in compression, without the need for screws and nuts, which are thus completely eliminated.

It should be understood that though, for purposes of illustration and description, an embodiment of the invention is described that includes an injection molding process, the scope of the invention is not limited thereto, and encompasses other types of molding techniques including introducing a liquid material into a mold cavity, and allowing or causing said material to become a solid (or effectively a solid) material. For example, it is contemplated that the invention includes such process steps as, for example, introducing a thermoset plastic that is heated and then allowed to set, using a thermal plastic that is introduced as a liquid and undergoes a physical or chemical change in the presence of a catalyst, (or as its temperature changes), and/or using other methods known to those skilled in the art. The method of the present invention can be readily adapted to incorporate any of these techniques, or combinations thereof.

In accordance with another aspect of the present invention, current collectors are designed such that they are integrated into the lead frame structural elements in such a manner that the current collectors can act as compression plates within the molded fuel cell. This eliminates the need for separate compression plate components. In accordance with the invention, the mold cavity is designed such that when it closes, the fuel cell is compressed to a predetermined thickness dictated by a desired internal pressure. This allows pressure to be placed evenly across the entire active area of the cell. After the fuel cell is thus constructed and removed from the mold, the now formed plastic frame as well as the structurally enhanced current collectors hold the fuel cell component under a continuous pressure across the surface of the fuel cell. Accordingly, the level of compression obtained by this manufacturing process is both consistent and predictable from cell to cell when compared to the variability in compression observed in cells that are manually assembled.

The current collector, which also serves as the compression plate, may also indude flow fields to aid in the flow of the products and reactants in desired directions throughout the fuel cell. The current collector may also be designed to perform gas or liquid diffusion functions, depending upon the overall system design. This is described in commonly-owned U.S. patent application Ser. No. 10/260,820, filed on Sep. 30, 2002 by Ren et al for a FLUID MANAGEMENT COMPONENT FOR USE IN A FUEL CELL, which is presently incorporated herein by reference.

The NAFION® membrane and the current collectors can both be initially fabricated with openings around the perimeters thereof such that plastic in the mold process can flow through the openings and can form internal fasteners that hold the edges of the current collectors and NAFION® membrane in place.

In accordance with yet a further aspect of the invention, instead of hot pressing segmented MEAs and then inserting them into a lead frame for molding, the diffusion layer materials are applied directly to the current collectors on the lead frame components and are thereafter hot pressed to the current collectors collectors, which are fastened or bonded to the MEA. This assembly is then insert molded to create a sealed fuel cell, or full fuel cell array. Fabricating the current collectors to provide gas diffusion properties may aid in this effort.

### BRIEF DESCRIPTION OF THE DRAWINGS

The invention description below refers to the accompanying drawings, of which:

FIG. 1 is an exploded perspective view of a single cell constructed in accordance with one aspect of the invention;

FIG. 2A is a top plan view of the anode side of the fuel cell in the lead frame as assembled prior to molding;

FIG. 2B is a plan view of the cathode side of the fuel cell in the lead frame as assembled prior to molding;

FIG. 3 is a flow chart illustrating a procedure in accordance with the present invention;

FIG. 4 is a side section of the lead frame assembly taken along line A-A of FIG. 2A;

FIG. 5 is perspective view of the lead frame assembly illustrating apertures for plastic flow during the molding process;

FIG. 6 is a perspective view of the laminate cell assembly after the injection molding frame of the present invention;

FIG. 7 is a perspective view of the finished cell assembly after the trimming process;

FIG. 8A is an exploded view of the fuel cell components prior to assembly for the combined hot pressing and insert molding process of the present invention;

FIG. 8B is an exploded view of the fuel cell components in which the diffusion layer materials have been applied to the current collectors; and

FIG. 9 is a flow chart illustrating the combined procedure for hot pressing and insert molding a fuel cell in accordance with the present invention.

### DETAILED DESCRIPTION OF AN ILLUSTRATIVE EMBODIMENT

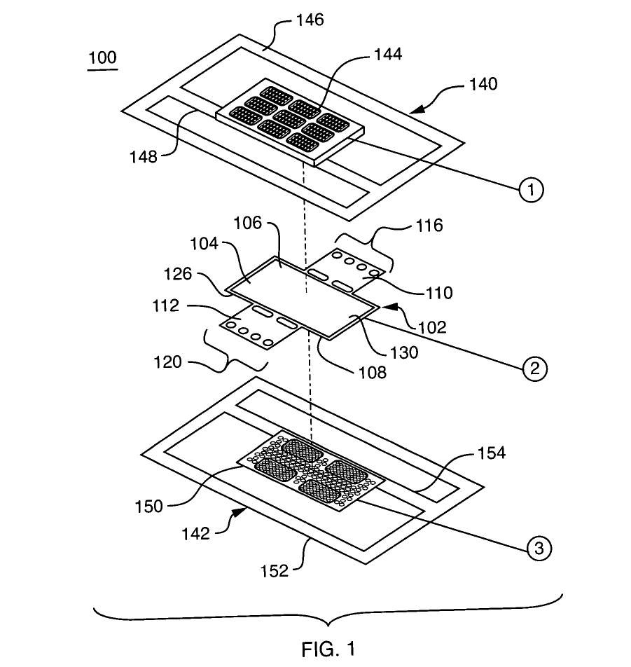

FIG. 1 is an exploded perspective view of a lead frame assembly and other components of the fuel cell fabricated in accordance with one aspect of the invention. More specifically, the lead frame assembly 100 includes a membrane electrode assembly (MEA) 102. The MEA 102 typically includes a catalyzed membrane electrolyte 104, which may include a protonically conductive, electronically non-conductive membrane. One material that may be used for the catalyzed membrane, which is commercially available is NAFION®, a registered trademark of E.I. Dupont de Nemours and Company, a cation exchange membrane based on a polyperflourosulfonic acid in a variety of thicknesses and equivalent weights. The membrane is typically coated on each of its major surfaces with an electrocatalyst such as platinum or a platinum/ruthenium mixture or alloyed particles (not shown). Thus, it is referred to herein as the “catalyzed membrane electrolyte, or the “catalyst coated membrane” (CCM). One face of the catalyzed membrane electrolyte 104 is the anode face or anode aspect 106. The opposing face of the catalyzed membrane electrolyte 104 is on the cathode side and is herein referred as the cathode face or the cathode aspect 108 of the membrane electrolyte 104. Diffusion layers comprised of carbon paper, carbon cloth, metallic substances, and/or microporous plastics may be provided on the anode side, the cathode side or both. Some of these components are described in commonly owned U.S. patent application Ser. No. 10/413,983 filed by Ren et al., on Apr. 15, 2003, for a DIRECT OXIDATION FUEL CELL OPERATING WITH DIRECT FEED OF CONCENTRATED FUEL UNDER PASSIVE WATER MANAGEMENT, which is incorporated herein by reference. The catalyzed membrane electrolyte sandwich may be constructed according to any of the various available fabrication techniques, or other fabrication techniques, while still remaining within the scope of the present invention.

In accordance with one aspect of the invention, the catalyzed membrane electrolyte, or CCM, 104 is die cut to include welding extension tabs, 110 and 112. The tabs include a plurality of openings that are collectively designated in FIG. 1 as openings 116 on tab 110, and openings 120 on tab 112. The active area of the CCM 104 is the rectangular area 130.

The lead frame assembly 100 of the present invention includes a lead frame component 140 on the anode side and a lead frame component 142 on the cathode side. In accordance with the invention, the lead frame components not only hold the assembly together, but also integrate current collector functionality. More specifically, an anode current collector 144 is incorporated into the anode lead frame component 140. Thus, the anode current collector includes the exterior frame portion 146, and a current collecting lead 148. Similarly, on the cathode side, a cathode current collector 150 is integrally formed as part of the cathode lead frame component 142 and includes an exterior frame portion 152 and a current collecting lead 154.

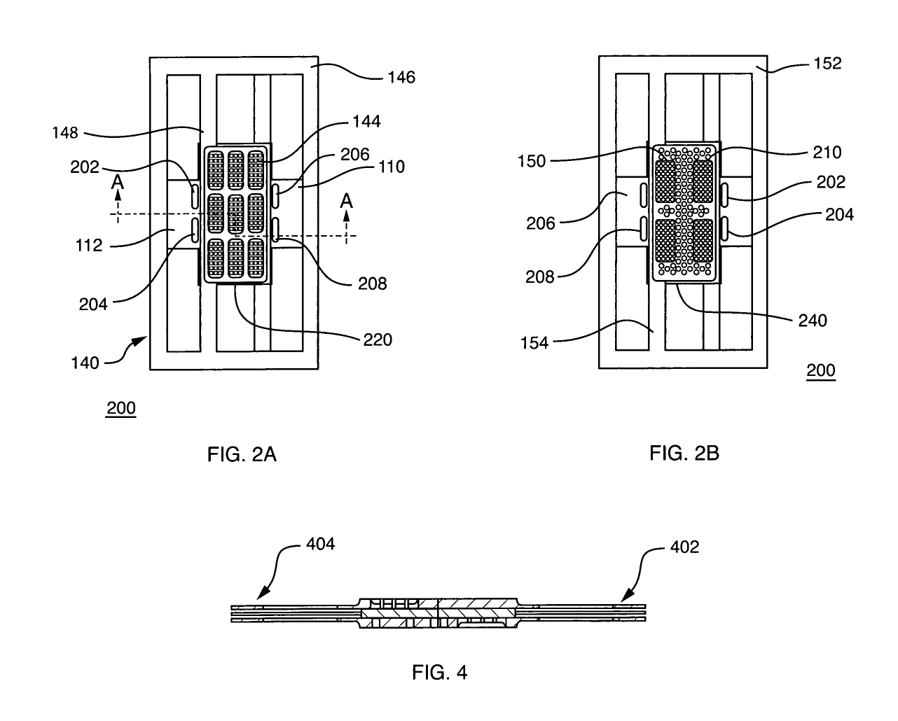

The assembled laminate cell 200 of the present invention, prior to the molding process, as viewed from the anode side is illustrated in FIG. 2A, in which like components have the same reference characters as in FIG. 1. The anode lead frame component 140 incorporates the anode current collector 144. The extension tab 112, for example, of the catalyzed membrane 104, has openings 202 and 204 on the one side, and the extension tab 110 has openings 206 and 208 on the other side for use in the molding process as described further hereinafter. The anode current collector 144 of the laminate cell assembly 200 of FIG. 2A includes a continuous raised surface 220 around the active area of the PCM to provide a shut off face for the mold face during the molding process.

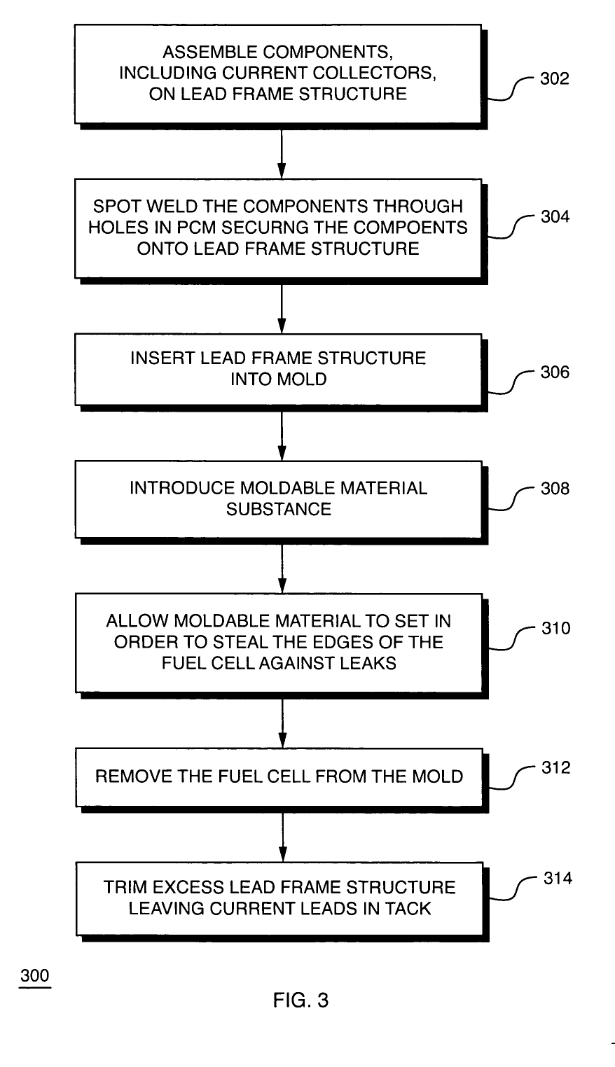

Similarly, on the cathode side illustrated in FIG. 2B, cathode current collector 150 of the cathode lead frame component 152, includes a continuous raised surface 240 around the active area of the PCM to provide a shut off face for the mold plate during the molding process on the cathode side. The openings 202, 204, 206 and 208 are also visible from on the opposite side of the assembled laminate cell that is illustrated in FIG. 2B from the cathode side. Openings 202, 204, 206, 208 allow plastic to flow through the PCM thereby securing it in place. Further, on the cathode side, the cathode current collector 150 is also provided with a plurality of apertures generally designed as apertures 210, through which oxygen needed for the cathode half reaction can travel, either as ambient air or from a dedicated oxygen source (not shown). The method of fabricating a fuel cell in accordance with the present invention may be understood with reference to the flow chart of FIG. 3. The process 300 begins with step 302 which includes assembling the fuel cell components, such as those previously described with reference to FIG. 1, including the anode lead frame component 140 that integrates anode current collector 144, and the cathode lead frame component 142 that integrates cathode current collector 150. As noted, the MEA 102 is sandwiched between the lead frame component 140 and lead frame component 142.

After the MEA components are placed within the lead frame assembly, the components are spot welded together through holes in the NAFION®, 116 and 120, securing the components in place for the molding process. This process step is illustrated in the flow chart of FIG. 3 as step 304. This step can also be better understood with reference to FIG. 4 which is a side section of the fuel cell assembly taken along lines A-A of FIG. 2A. It shows the spot welding areas 402 and 404 from another perspective. It should be understood by those skilled in the art that it may be desirable, for example, to spot weld other surfaces or portions of the assembly in different circumstances while remaining within the scope of the present invention. It may also be useful in certain applications to eliminate the spot welding through the NAFION®. In such a case only the compression of the lead frame holds the MEA in place. Additionally, the spot welding may be eliminated altogether by providing an alternative lead frame assembly method such as rivets, glue, snap fits, etc.

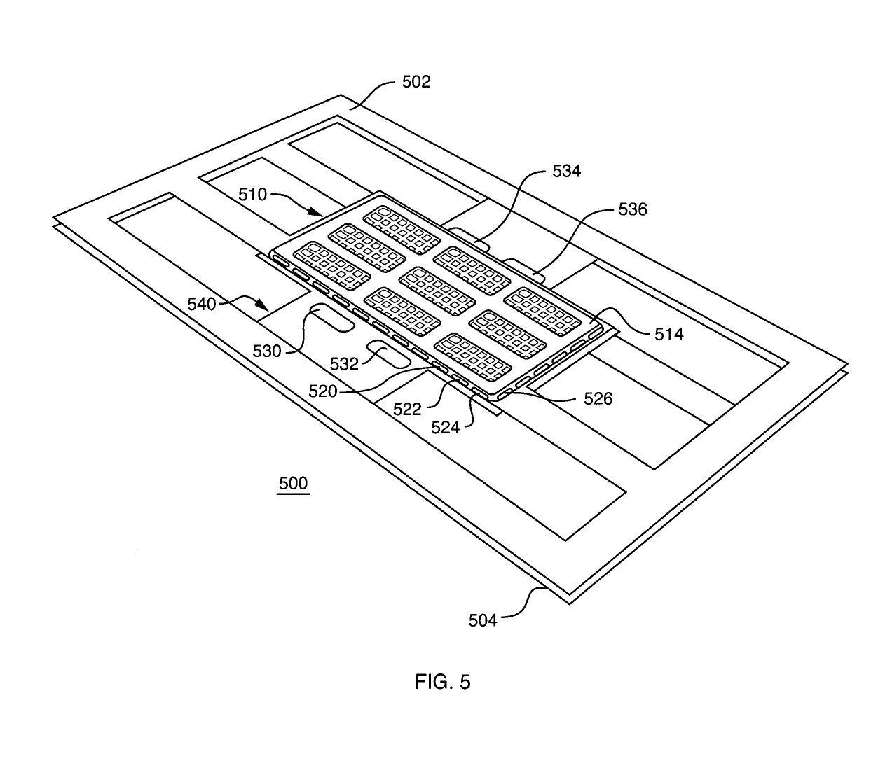

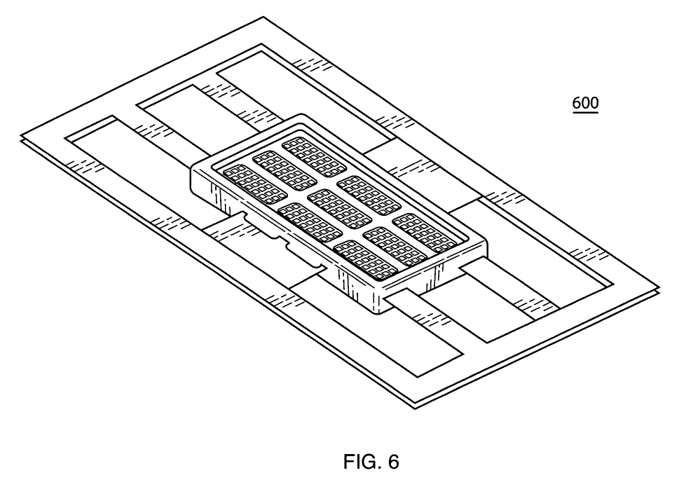

The lead frame assembly 200 (FIGS. 2A and 2B), containing the previously assembled components of the fuel cell, now spot welded together for maintaining the components in the desired relative locations, is inserted into a mold cavity as illustrated in step 306. It is noted that a suitable mold should be constructed in accordance with techniques known to those skilled in the art such that the mold produces a frame of predetermined dimension around the fuel cell. The mold plates are clamped together around the fuel cell components, and the perimeter raised surfaces in each current collector provide a shut off face for the mold plates. These shut off surfaces are best understood with reference to FIG. 5.

FIG. 5 is a perspective view of the lead frame assembly 500 with the components assembled therein prior to injection molding. The lead frame assembly 500 has a first lead component 502 and a second lead frame component 504. The visible component 502 has a current collector 510 integrated into it. As described further hereinafter with respect to an alternative embodiment of the invention, the current collector portion 510 may be constructed in such a manner that it also performs the functions of a diffusion layer, thus eliminating the need for a separate diffusion layer. The current collector 510 includes a continuous raised surface 514 around the active area of the current collector, this raised surface stops further progress of the mold plate toward the active surface of the current collector and substantially prevents “flash” between the mold plate and current collector, which occurs when thin webs of surplus plastic are undesirably formed between mating surfaces.

Around the outside perimeter of the shut off surfaces such as the surface 514 of FIG. 5, there are multiple apertures 520, 522, 524 and 526, for example, provided the current collector 510. These apertures, 520 through 526, allow plastic to flow through and grip the components more firmly. The diffusion layers, not shown, are dense and the plastic is viscous such that any lateral flow of plastic into the active area of the diffusion layer is substantially prevented so that, for example the anode diffusion layer is open to allow mass transport of fuel into the anode aspect, and the cathode diffusion layer allows oxygen to flow through to the cathode aspect of the fuel cell. Gasketing or other appropriate sealing methods could be used to prevent impregnation into the active areas, should a less dense backing (diffusion layer) be employed on one or both sides of the fuel cell. There are also apertures 530, 532, 534 and 536, for example, in the PCM membrane 540 to allow for plastic to flow through. As noted herein, the apertures may be varied in shape, location or number depending upon the particular application circumstances, while remaining within the scope of the present invention.

Returning now to the flow chart of FIG. 3, in accordance with step 308, a fluid plastic material is introduced into the mold cavity. The plastic flows into the mold around the fuel cell. A variety of plastic materials may be suitable for use in the molding step, depending upon the molding technique being used in a particular application of the invention. In some instances, it is preferable to use a relatively low-temperature plastic in order to minimize the heat experienced by the cell while in the mold. For example, a suitable material that possesses adequate strength for this application would be a glassfilled or glass-coupled thermoplastic. By way of example, and not by way of limitation, an acetal copolymer sold commercially as “CELCON®” is a suitable material Other materials that may be used include. But are not limited to is VALOX®, DELRIN®, UDEL®, VECTRA®B, and ULTEM®, or suitable combinations of any of these materials. A number of plastics are suitable for use in the invention, and the following table summarizes these materials, which are provided by way of example, and not of limitation.

| | Example | |
|---|---|---|
| Generic/Chemical Name | Trade Name | Manufacturer |
| acetal copolymer or POM (poly- | Celcon | Ticona |
| oxymethylene) | | |
| acetal homopolymer or POM | Delrin | DuPont |
| PBT (polybutylene terephthalate) | Valox | GE Plastics |
| Polysulfone | Udel | Solvay Advanced |
| | | Polymers, L. L. C. |
| LCP (liquid crystal polymer) | Vectra | Ticona |
| PEI (polyetherimide) | Ultem | GE Plastics |

As the plastic cures, as indicated in step 310, a dense, solid plastic frame is created around the fuel cell. This securely seals the edges of the fuel cell against leaks. The plastic forms a seal in the outer borders of the diffusion layers and tightly blocks any undesired pathways that could give rise to leaking fuel or water leakage. This eliminates the need for gasketing. The lead frame assembly itself is designed so that the more fragile internal components such as the catalyzed membrane and the active areas of the diffusion layers of the fuel cell are protected by the current collectors while the molding process takes place.

In addition to sealing the fuel cell, the frame manufactured in accordance with the present invention also holds the components of the cell in compression. Adequate compression is important for obtaining efficient current collection. Typically, compression is achieved by tight screws, bolts and other fasteners. However, in accordance with the present invention, compression in the fuel cell is introduced by the mold plates themselves. The mold cavity is designed in accordance with the invention such that when it closes, it compresses the cell to decrease the thickness dictated by the selected internal pressure. Pressure is placed substantially evenly across the entire active area of the cell during the molding process and after the molding is complete this pressure is maintained by the plastic frame, which is securely formed around the fuel cell components and remains stationary, applying substantially constant pressure. Alternatively, the mold may include compliant surfaces to apply pressure evenly across the entire active area of the cell regardless of the thickness of the cell. Alternatively, the compliant mold may be fabricated using methods known to those skilled in the art.

During the insert molding process, in order to minimize the heat experienced by the MEA and specifically the membrane electrolyte, while in the mold, a polymer with a relatively low melting temperature may be selected. This low temperature plastic may be injected at the lowest possible temperature in the workable range for the material. The temperature that will typically be used is much less than the maximum temperatures that is the MEA has been shown to endure. For instance where a NAFION® membrane electrolyte is used, it is desirable to maintain a temperature of less than 215 degrees Fahrenheit. The actual temperature threshold is a function of many factors including, but not limited to time and materials selected.

Additionally, a protective film or tape can optionally be placed across the surfaces of the current collectors prior to insertion into the mold if additional protection is desired from volatile vapors or other contaminants. This film or tape can also be used to help retain moisture in the cell.

After the introduction of the plastic, the fuel cell is held in place while the plastic cools to the mold temperature to allow full solidification of the plastic frame. The fuel cell is then removed from the mold as noted in step 312 of FIG. 3. Finally, as indicated by step 314 of the flow chart of FIG. 3, excess material from the lead frame structure is trimmed leaving the finished fuel cell.

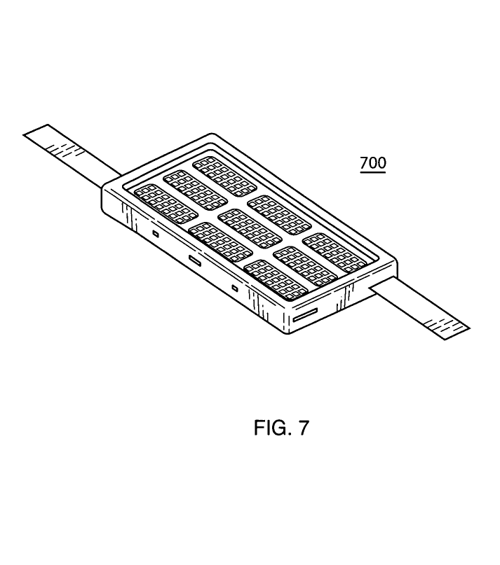

The completed frame 600 around the fuel cell is illustrated in FIG. 6. The molded frame maintains a much more consistent level of compression from cell to cell than is produced using the current manual assembly method. The completed fuel cell 700 manufactured in accordance with this aspect of the present invention is illustrated in FIG. 7.

The manufacturing time for fabricating a single insert-molded fuel cell in accordance with the present invention, once components are collected, involves 1-2 minutes for assembly of the lead frame, approximately one minute cycle time for the molding process (including the time needed for manually inserting the lead frame into the mold) and less than one minute to trim the excess lead frame material away from the finished cell. The steps in the process could potentially be automated, including assembly of the components onto the lead frame, insertion of the lead frame assembly into the mold, and trimming, thus further reducing cycle time. Furthermore, costly and potentially inconsistent manual work is also eliminated when automating the various steps. Manufacturing time is also greatly reduced by molding more than one cell at a time in a cavity. Additionally, the method described above can be applied to fuel cell arrays in which the cells may be previously connected in series before the lead frame is molded.

In accordance with another aspect of the invention, the manufacturing process of a fuel cell can be improved by combining the certain bonding techniques used to laminate fuel cell components with techniques for insert molding the fuel cell or fuel cell array.

More specifically, and as noted herein, typically a fuel cell is made by first creating the membrane electrode assembly by catalyst coating a protonically conductive membrane and then placing diffusion layer materials on each side. Typical diffusion layer materials include carbon cloth and/or carbon paper, however diffusion layers may further include plastics and metals. Typically, these items are placed in close proximity to each other and laminated together using hot press operation. Similar to an injection molding process, the hot press process involves bonding two or more components together by pressing two plates together and applying substantial force at the desired temperature.

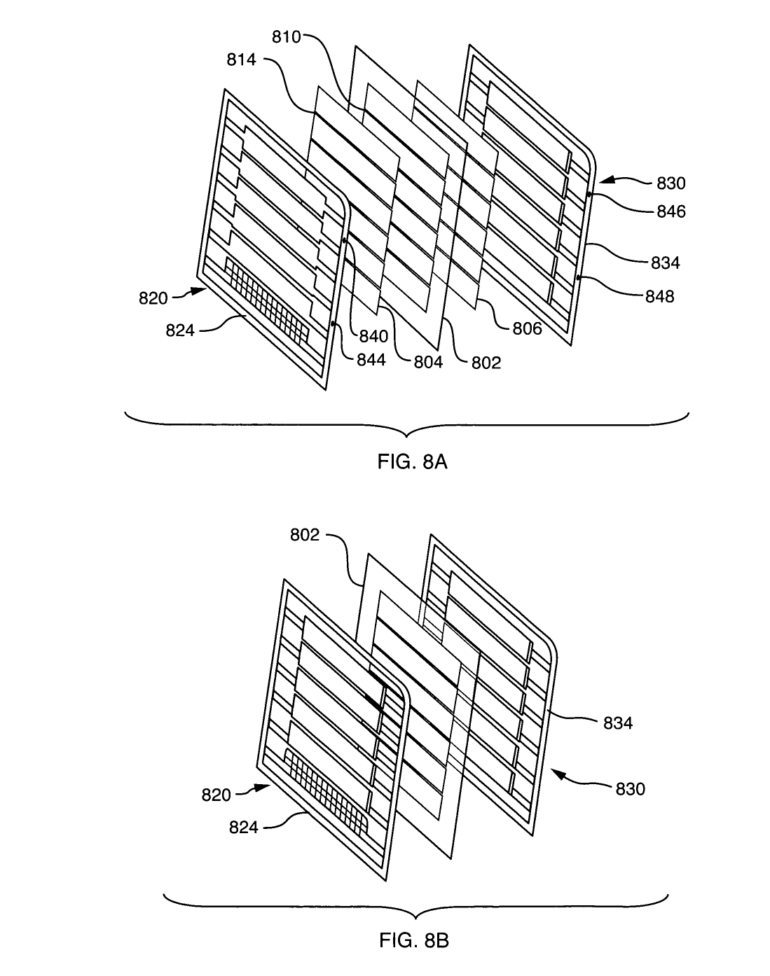

In accordance with the present invention, instead of separately hot pressing segmented membrane electrode assemblies together in accordance with prior techniques and then inserting them to a lead frame for molding, these steps may be combined. More specifically, as illustrated in FIG. 8A, a protonically conductive membrane 802 will already include catalyst coatings (not shown). Sometimes the protonically conductive membrane is referred to herein as a catalyst coated membrane (CCM). On each side of the catalyst coated membrane there are diffusion layers as will be understood by those skilled in the art. Sometimes the diffusion layers are referred to as gas diffusion layers (GDL). On the anode side, for example, in FIG. 8A gas diffusion layer 804 will allow the mass transport of a fuel substance to the anode aspect of the MEA 802. On the cathode side the diffusion layer 806 allows for the mass transport of oxygen to the cathode aspect of the membrane electrode assembly 802. The diffusion layer may also serve to retain humidity in the cathode chamber as desired or to allow water vapor to escape out of the cathode chamber as desired in a particular application. On the anode side, in addition to allowing the mass transport of fuel toward the anode aspect of the membrane electrode assembly 802, the diffusion layer may also be constructed in a manner that allows the exit of carbon dioxide which is generated in the anode half reaction in the fuel cell.

As noted, the protonically conductive membrane 802 is striated with lines 810, 812, etc. Similarly, the anode diffusion layer 804 has lines such as the line 814. The cathode diffusion layer 806 has lines 816. These are perforations that divide individual membrane electrode assemblies for separate fuel cells for a fuel cell array.

On gas aspect of the diffusion layer opposite the membrane electrolyte, a current collector is provided, as described in detail above. In accordance with the present invention, as described in detail with reference to the prior figures, the anode current collector 820 is integrated into a lead frame structure 824 for the convenience of handling and support during the insert molding process. Similarly, the cathode current collector 830 is integrated into a cathode lead frame structure 834 in the manner described in detail with reference to FIGS. 1-7 herein.

As illustrated in FIG. 8B, in accordance with this aspect of the invention, instead of first hot pressing segmented membrane electrode assemblies and then inserting them into a lead frame for molding, the diffusion material, such layer 806 is applied directly to the current collector 830, which is integrated into the lead frame 834. Thus, the lead frame structure 834 integrates a cathode current collector such as 830, which is visible in FIG. 8A, and to the diffusion material 816 has been applied as shown in FIG. 8B. Similarly, on the anode side, the anode diffusion materials 814 (as shown in FIG. 8A) are applied directly to the anode current collector 820. The anode materials are not visible in FIG. 8B, but the entire assembly as shown in FIG. 8B, due to the perspective from which FIG. 8B is shown. The anode diffusion materials applied to the anode current collector 820 and the cathode diffusion materials applied to the cathode current collector 830, including the catalyzed membrane electrolyte can then be inserted into the mold device and can be hot pressed in combination with an injection molding process in accordance with the present invention.

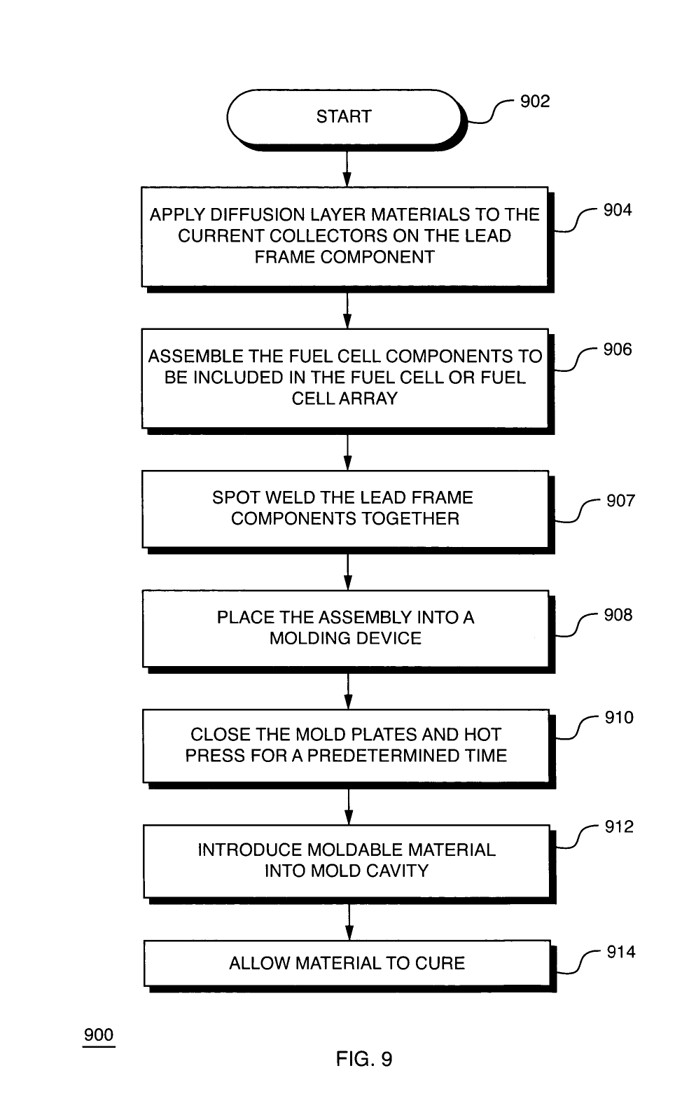

More specifically, FIG. 9 is a flow chart illustrating a procedure 900 for a combination of hot pressing and molding of a fuel cell, or an array of fuel cells, in accordance with the present invention in which the procedure is initiated in step 902. As illustrated in step 904, and as shown in FIG. 8B, the diffusion layer materials are applied to the lead frame components that incorporate the current collectors. This can be accomplished by applying a coating of an appropriate material to carbon paper or carbon cloth. Such materials may have been treated to have certain hydrophobic or hydrophilic properties Other techniques such as hot pressing, ultrasonic welding or adhesive binding may be used to bond the diffusion layer materials onto the current collectors.

Next, the components to be included in the fuel cell or fuel cell array are then assembled in accordance with step 906. The components include a protonically conductive, electronically non-conductive membrane that has been catalyzed. This membrane will be supplied with cutouts to allow for plastic flow through the membrane as described with reference to the previous embodiment, and if an array of cells is being created, cutouts will be provided between the individual MEAs. Optionally, the membrane could be supplied on a tape, which may be segmented to create individual cells in an array. If desired, additional materials such as Teflon® and other suitable materials can be added around the perimeter or other non-active portions of the membrane to strengthen the membrane and to improve leak-resistance. Adding such materials can also serve to lower the cost and simplify the combination hot press and molding process. Assembled with the catalyzed membrane are the lead frames with integrated current collectors, which have diffusion layers applied as described, on each aspect of the MEA.

Once all of the materials are assembled, the lead frames are spot welded together as illustrated in step 907, in order to maintain the various components in place in the mold device. For example, area 840 and 844 on the lead frame component 824 (FIG. 8A) can be spot welded to areas 846 and 848, respectively, on the lead frame component 834.

The next step 908 is to place the assembly into a suitable mold device, as described earlier in this application. The mold plates are then closed and heat is applied for a predetermined time period to hot press the components of the fuel cell as indicated in step 910. The time period may be on the order of approximately 4 minutes at a temperature of approximately 215 degrees Fahrenheit. However, those settings are for one example of the invention and the times may vary substantially while remaining within the scope of the present invention. The hot pressing step bonds the diffusion layers to the current collectors.

Now, without needing to move the assembly components to another device, a material suitable for molding is introduced into the mold cavities illustrated in step 912 of FIG. 9. The material is then allowed to cure as illustrated in step 914. The molding step will take on the order of about 1 minute. This will create a frame around the fuel cells in the array and will induce the compression necessary for adequate conductivity. A plastic frame is created around each individual cell, if desired, in the fuel cell array embodiment of the invention. It is noted that in some embodiments of the invention, the frame may be comprised of a non-plastic, but moldable material, and this is contemplated as being within the scope of the the present invention. It should be understood that the present invention provides a number of advantages in the fabrication and sealing of a fuel cell. The novel current collectors that are integrated into the lead frame can also be fabricated as both flow field plates and compression plates thus eliminating separate compression plates and flow field plates in certain embodiments of the invention. The compression introduced in the insert molding process also eliminates the need for screws, nuts and bolts that add bulk to the system and time to the manufacturing process due to manual assembly. The manual assembly process also creates inconsistencies in the results. Furthermore, the injection molded frame around the fuel cell results in a cell that is sealed against leakage of fuel and water, while eliminating some or all of the previously required gasketing around the cell. In addition, the hot pressing technique facilitates low cost manufacturing by substantially shortening cycle time and by reducing of component count.

The foregoing description has been directed to specific embodiments of the invention. It will be apparent, however, that other variations and other modifications may be made to the described embodiments, with the attainment of some or all of the advantages of such. Therefore, it is the object of the appended claims to cover all such variations and modifications as come with in the true spirit and scope of the invention.

1. A method of fabricating a membrane electrode assembly for use in a fuel cell, including the steps of:
(A) providing a mold that includes a first and second mold plate adapted to impart a desired shape;
(B) providing a lead frame, including at least a first lead frame component that is adapted to be received into said mold;
(C) assembling a protonically conductive membrane with catalyst coatings on each of its major surfaces onto said first lead frame component;
(D) placing said lead frame containing said membrane into the mold;
(E) compressing said second mold plate onto said first mold plate;
(F) introducing a moldable material in communication with said mold plates; and
(G) allowing the moldable material to cure in said mold to solidify and form a frame around said membrane to produce a membrane electrode assembly for use in a fuel cell.

2. The method as defined in claim 1 including the further step of integrating a current collector into said first lead frame component onto which said membrane is placed.

3. The method as defined in claim 2 including the further steps of:
(A) providing a second lead frame component that includes a second current collector; and
(B) sandwiching said catalyzed membrane between the first and second current collectors;
(C) introducing the lead frame components into said mold;
(D) compressing the first and second mold plates together;
(E) introducing a moldable material into said mold;
(F) allowing the moldable material to cure to form the shape of the mold plates thereby forming a sealed fuel cell.

4. The method as defined in claim 1 wherein the step of introducing the moldable material includes injection molding a moldable material into said mold.

5. The method as defined in claim 1 wherein the step of introducing the moldable material includes placing said moldable material onto said mold plates and casting a frame around the membrane electrode assembly.

6. A method of fabricating a fuel cell array, including the steps of:
(A) providing a mold that includes a first and second mold plate of a desired shape;
(B) providing a sheet of protonically conductive membrane material that has been coated on each of its major surfaces with a catalyst material to form a sheet of catalyzed membrane;
(C) providing a lead frame structure that includes a plurality of individual lead frame components that define separate fuel cells;
(D) assembling said sheet of catalyzed membrane into said lead frame structure;
(E) placing said lead frame structure containing said membrane sheet into the mold;
(F) compressing said second mold plate onto said first mold plate;
(G) introducing a moldable material in communication with said mold plates; and
(H) allowing the plastic to cure in said mold to solidify and form a frame around said individual fuel cells to produce a fuel cell array.

7. A method of establishing a seal around a fuel cell, comprising the steps of:
(A) providing a lead frame assembly including:
(i) providing first and second current collectors adapted to serve as lead frame components in an associated mold device;
(ii) assembling fuel cell components including:
(a) a catalyzed protonically conductive, electronically non-conductive membrane; and
(b) first and second diffusion layers disposed on opposite sides of said membrane;
(iii) arranging said fuel cell components between said first and second current collectors;
(B) inserting the resulting lead frame assembly into a molding device;
(C) introducing a moldable material into said molding device; and
(D) allowing said moldable material to cure to seal the edges of the lead frame assembly against leaks to thereby seal the fuel cell.

8. The method as defined in claim 7 comprising the further step of spot welding the first and second current collectors that serve as lead frame components together to maintain the components in place.

9. The method as defined in claim 7 including the further step of trimming excess lead frame component portions away from said fuel cell to result in a finished fuel cell.

10. The method as defined in claim 7 including the further step of providing said mold device with a mold cavity which, when said moldable material is introduced into said mold cavity and cured, creates a frame around said fuel cell.

11. A method of establishing a sealed diffusion layer for use in a fuel cell including the steps of:
(A) providing a first current collector integrated into a lead frame component;
(B) applying a diffusion layer material to said first current collector on said lead frame component;
(C) providing a second current collector integrated into a lead frame component;
(D) applying a second diffusion layer material to said second current collector on said lead frame component;
(E) placing a catalyzed protonically conductive, electronically non-conductive membrane between said first lead frame component and said second lead frame component to form an assembly;
(F) placing said assembly into a molding device;
(G) closing mold plates associated with said molding device and hot pressing the assembly for a predetermined time period;
(H) introducing a moldable material into said mold cavity of said mold device; and
(I) allowing said moldable material to cure to seal said lead frame components integrating said first and second current collectors together to form a fuel cell.

12. The method as defined in claim 11 wherein step (H) includes an insert molding technique.

13. The method as defined in claim 11 including the further step of spot welding said first and second lead frame components together to maintain said components in position prior to placing the assembly into the molding device.

14. A method of introducing compression into a fuel cell, comprising the steps of:
(A) providing a catalyst coated membrane;
(B) providing a first current collector integrated into a first lead frame component suitable for being received into a molding device;
(C) providing a second current collector integrated into a second lead frame component suitable for being received into a molding device;
(D) assembling said first and second current collectors on either side of said membrane to result in an assembly;
(E) placing said assembly into said mold device that has been provided with mold plates;
(F) closing said mold plates and maintaining said mold plates in a closed position to induce compression; and
(G) introducing a moldable material into the resulting mold cavity thereby creating a frame around the fuel cell that maintains compression within said fuel cell without the need for mechanical fasteners.

15. A fuel cell manufactured by the steps of:
(A) providing a lead frame assembly including:
(i) providing first and second current collectors adapted to serve as lead frame components in an associated mold device;
(ii) assembling fuel cell components including:
(a) a catalyzed protonically conductive, electronically nonconductive membranes; and
(b) first and second diffusion layers disposed on opposite sides of said membrane;
(iii) arranging said fuel cell components between said first and second current collectors;
(B) inserting said lead frame assembly into an insert molding device;
(C) introducing a moldable material into said insert molding device; and
(D) allowing said moldable material to cure to seal the edges of the lead frame assembly against leaks to thereby form a sealed fuel cell.

16. A component for use in a direct oxidation fuel cell comprising:
(A) a conductive material suitable for use as a current collector;
(B) a second material applied to said conductive material, which second material acts as a diffusion layer in a fuel cell; and
(C) a lead frame structure disposed around said current collector material for handling said component during a molding process.

17. The component as defined in claim 16 wherein a plurality of apertures are disposed within said current collector for plastic flow through during an insert molding process.

18. A direct oxidation fuel cell comprising:
(A) a catalyzed membrane electrolyte;
(B) an anode current collector disposed generally parallel to an anode aspect of said catalyzed membrane electrolyte, said anode current collector including an anode diffusion layer material that has been hot pressed to seal said diffusion layer material onto said current collector; and
(C) a cathode current collector disposed generally parallel to a cathode aspect of said membrane electrolyte, a cathode diffusion layer material having been hot pressed onto said cathode current collector to seal it against leakages; and
(D) disposing said catalyzed membrane between said anode current collector and said cathode current collector, a load connected across said anode current collector and said cathode current collector to utilize the electricity produced in reactions generated when a fuel substance and oxygen are introduced.

19. The direct oxidation fuel cell as defined in claim 18 wherein said anode current collector includes pores sized in such a manner that the anode current collector functions as a diffusion layer.

20. The direct oxidation fuel cell as defined in claim 18 wherein said cathode current collector includes pores sized in such a manner that the cathode current collector functions as a diffusion layer.

21. The fuel cell as defined in claim 18 wherein said anode current collector includes channels therein such that said anode current collector also functions as a flow field plate.

22. The fuel cell as defined in claim 18 wherein said cathode current collector includes channels such that said cathode current collector functions as a flow field plate.
